(19) United States
(12) Patent Application Publication
(10) Pub. No.: US 2024/0361732 A1
(43) Pub. Date: Oct. 31, 2024

(54) METHOD FOR ROBOTIC MULTI-PEG-IN-HOLE ASSEMBLY BASED ON HIERARCHICAL REINFORCEMENT LEARNING AND DISTRIBUTED LEARNING AND SYSTEM THEREOF

(71) Applicant: SHANDONG UNIVERSITY, Jinan (CN)

(72) Inventors: Rui SONG, Jinan (CN); Xincheng TIAN, Jinan (CN); Xuewen RONG, Jinan (CN); Xin MA, Jinan (CN); Lelai ZHOU, Jinan (CN); Guoteng ZHANG, Jinan (CN); Hui CHAI, Jinan (CN); Zhe MIN, Jinan (CN)

(73) Assignee: SHANDONG UNIVERSITY, Jinan (CN)

(21) Appl. No.: 18/649,137

(22) Filed: Apr. 29, 2024

(30) Foreign Application Priority Data
Apr. 28, 2023 (CN) 2023105021037

(51) Int. Cl. G05B 13/02; B25J 9/16

(52) U.S. Cl. CPC G05B 13/0265; B25J 9/163

(57) ABSTRACT

A method and system for robotic multi-peg-in-hole assembly based on hierarchical reinforcement and distributed learning, including: establishing a master-control assembly-strategy model based on deep reinforcement learning by using data of states and actions of a robot; constructing a plurality of sub-process networks based on different assembly interaction environments, updating and training the master-control assembly-strategy model by using interaction data of the robot obtained by the constructed plurality of sub-process networks, and obtaining a trained master-control assembly-strategy model; and controlling and instructing the robot to execute an assembly task of a robotic multi-peg-in-hole assembly by using the trained master-control assembly-strategy model. By utilizing a manner of constructing a sub-process network in a plurality of different environments to update an overall network, comparing with an ordinary reinforcement learning algorithm, the final effect of the robot learning can be improved, the efficiency of the robot learning is improved, and learning time is saved.

### TECHNICAL FIELD

The present invention belongs to the technical field related to robot assembly, and particularly relates to a method for robotic multi-peg-in-hole assembly based on hierarchical reinforcement learning and distributed learning, and a system thereof.

### BACKGROUND

The statements in this section merely provide background information related to the present invention and do not necessarily constitute prior art.

The learning efficiency of assembly tasks and how to deal with complex assembly objects are one of the problems that need to be solved urgently for robots to improve their complex assembly skills. In a process of multi-peg-in-hole assembly and complex electrical connector assembly, it takes a long time for a robot to learn because of the complexity of assembly objects and the difficulty of obtaining interactive data. In addition, a reward function in a interactive process is difficult to shape, which brings difficulties to the learning process of the robot. Therefore, how to make the robot learn the assembly skill for complex multi-peg-in-hole assembly more efficiently, reduce a learning time for robot learning, and be able to deal with the assembly of the complex multi-peg-in-hole and other objects is an urgent problem to be solved.

### SUMMARY

In order to overcome the shortcomings of the prior art, the present invention provides a method and system for robotic multi-peg-in-hole assembly based on hierarchical reinforcement learning and distributed learning, which utilizes a manner of constructing a sub-process network in a plurality of different environments to update an overall network, and compared with an ordinary reinforcement learning algorithm, a final effect of the robot learning can be improved, an efficiency of the robot learning is improved, and a learning time is saved.

To achieve the above object, a first aspect of the present invention provides a method for a robotic multi-peg-in-hole assembly based on hierarchical reinforcement learning and distributed learning, comprising:
establishing a master-control assembly-strategy model based on deep reinforcement learning, wherein, an input of the model is states of a robot, and an output of the model is actions of the robot;
constructing a plurality of sub-process networks based on different assembly interaction environments, updating and training the master-control assembly-strategy model by utilizing robot interaction data obtained by the constructed plurality of sub-process networks, and then obtaining a trained master-control assembly-strategy model; wherein,
each of the plurality of sub-process networks comprises a high-level strategy network and a low-level strategy network, wherein the high-level strategy network obtains a high-level strategy value according to data of a state of the robot at a current time, and the low-level strategy network obtains an action of the robot at a next time according to the high-level strategy value and the data of the state of the robot at the current time;
and, controlling and instructing the robot to execute an assembly task of a multi-peg-in-hole assembly by utilizing the trained master-control assembly-strategy model.

A second aspect of the present invention provides a system for a robotic multi-peg-in-hole assembly based on hierarchical reinforcement learning and distributed learning, comprising:
a master-control assembly-strategy model establishing module, being configured to: establish a master-control assembly-strategy model based on deep reinforcement learning by using data of states and actions of a robot;
a master-control assembly-strategy model training module, being configured to: construct a plurality of sub-process networks based on different assembly interaction environments, update and train the master-control assembly-strategy model by utilizing interaction data of the robot obtained by the constructed plurality of sub-process networks, and obtain a trained master-control assembly-strategy model; wherein,
each of the plurality of sub-process network comprises a high-level strategy network and a low-level strategy network, wherein the high-level strategy network obtains a high-level strategy value according to data of a state of the robot at a current time, and the low-level strategy network obtains an action of the robot at a next time according to the high-level strategy value and the data of the state of the robot at the current time;
and, a robot controlling and executing module, being configured to: control and instruct the robot to execute an assembly task of a robotic multi-peg-in-hole assembly by utilizing the trained master-control assembly-strategy model.

A third aspect of the present invention provides a computer device comprising a processor, a memory, and a bus, wherein the memory storing machine-readable instructions executable by the processor, the processor communicating with the memory via the bus when the computer device is operating; when the machine-readable instructions are executed by the processor, implementing a method for a robotic multi-peg-in-hole assembly based on hierarchical reinforcement learning and distributed learning.

A fourth aspect of the present invention provides a non-transitory computer-readable storage medium having a computer program stored thereon; when the computer program executed by a processor, implementing a method for a robotic multi-peg-in-hole assembly based on hierarchical reinforcement learning and distributed learning.

### One or More of the Above Technical Solutions have the Following Beneficial Effects

The present invention utilizes a manner of constructing a plurality of sub-process networks in different environments to update an overall network, compared with an ordinary reinforcement learning algorithm, which can improve a final learning effect of the robot learning and a learning efficiency of the robot learning, and save a learning time.

In the present invention, the sub-process network comprises a high-level strategy network and a low-level strategy network, a learning of the network is accelerated by training the high-level strategy network and the low-level strategy network in each sub-process, and a main-control assembly-strategy network is updated by utilizing the sub-process network, so that a learning time of the robot can be reduced, and an assembly of objects such as complex multi-peg-in-hole and the like can be handled.

Additional aspects of the present invention will be set forth in part in the description which follows, and in part will be obvious from the description, or may be learned by practice of the present invention.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a schematic diagram of a learning process of a model based on hierarchical reinforcement learning and distributed learning in an Embodiment 1 of the present invention;

FIG. 2 is a schematic diagram of a process of hierarchical reinforcement learning according to the Embodiment 1 of the present invention;

FIG. 3 is a schematic diagram of a process of reward shaping according to the Embodiment 1 of the present invention;

FIG. 4 is a schematic diagram of updating a low-level strategy network according to the Embodiment 1 of the present invention; and

FIG. 5 is a schematic diagram of updating a high-level strategy network according to the Embodiment 1 of the present invention.

### DETAILED DESCRIPTION

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used herein are merely used for describing specific implementations, and are not intended to limit exemplary implementations of the present invention.

The embodiments and features of the embodiments in this disclosure may be combined with each other without conflict.

### Embodiment 1

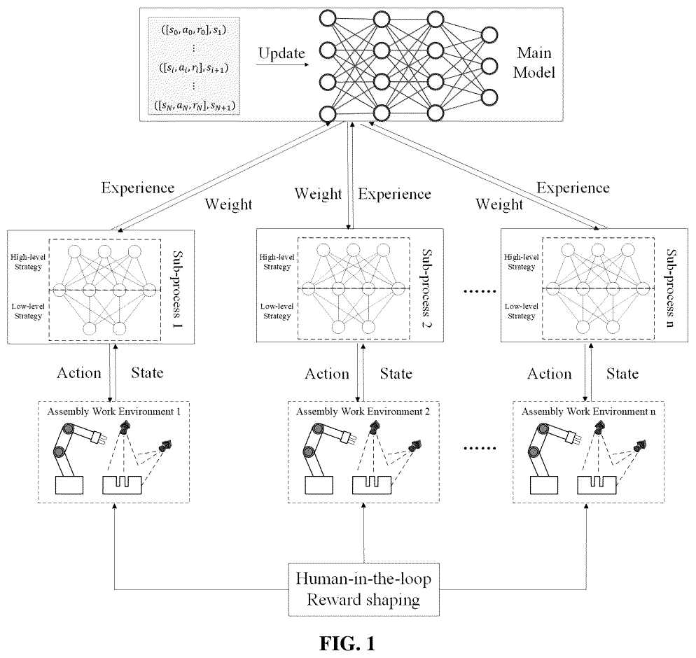

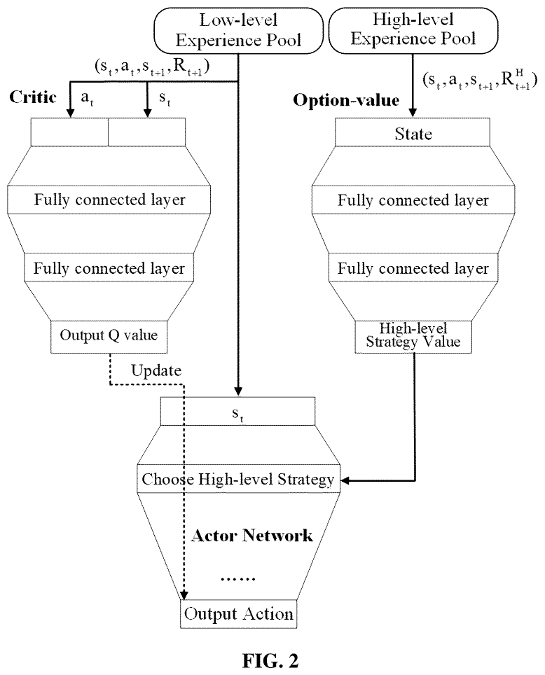

As shown in FIGS. 1-2, the present embodiment discloses a method for a robotic multi-peg-in-hole assembly based on hierarchical reinforcement learning and distributed learning, comprising:
step 1, establishing a master-control assembly-strategy model based on deep reinforcement learning, wherein, an input of the model is states of a robot, and an output of the model is actions of the robot;
step 2, constructing a plurality of sub-process networks based on different assembly interaction environments, updating and training the master-control assembly-strategy model by utilizing robot interaction data obtained by the constructed plurality of sub-process networks, and then obtaining a trained master-control assembly-strategy model; wherein,
each of the plurality of sub-process network comprises a high-level strategy network and a low-level strategy network, wherein the high-level strategy network obtains a high-level strategy value according to data of a state of the robot at a current time, and the low-level strategy network obtains an action of the robot at a next time according to the high-level strategy value and the data of the state of the robot at the current time;
and, step 3: controlling and instructing the robot to execute an assembly task of a robotic multi-peg-in-hole assembly by utilizing the trained master-control assembly-strategy model.

In the present embodiment, a system including the robot, an end six-dimensional force sensor, two industrial cameras, an assembly object, etc. is built. The system constructs a state space of the network through position information, force information and image information of the end of the robot in multiple environments, constructs a shared feature space through feature extraction of the state and establishes an experience database, accelerates network learning by training the high-level strategy and the low-level strategy in each the process, wherein the reward function of the low-level strategy is shaped by a human-in-the-loop, then an experience of each the process is transmitted to a main process and a main network is updated, and then the main network assigns updated network weights to each the sub-network, wherein an output of the network is the action of the robot at the next time.

Specifically, in step 1 of the present embodiment, the state input to the network is defined as sₜ=(sₚ,s_{τ},s_{φ}), wherein, sₚ=[x,y,z,α,β,γ] represents a pose of components at the end of the robot, s_{τ}=[Fₓ,F_{y},F_{z},Mₓ,M_{y},M_{z}] represents the contact force/torque at the end of the robot, s_{φ} represents the image data acquired by the cameras, and aₜ=[Δx,Δy,Δz,Δα,Δβ,Δγ] represents a next assembly action of the robot.

And, a network structure of the master-control assembly-strategy model is consistent with that of the sub-process network, wherein the master-control assembly-strategy model does not participate in the environment interaction and only uses the data from the sub-process network to update its own the network structure.

In step 2 of the present embodiment, n sub-process networks based on different assembly interaction environments (i.e. different assembly objects) are constructed, and each of the n sub-process networks includes the high-level strategy network and the low-level strategy network.

Specifically, the high-level strategy network adopts a DQN (Deep Q Network), which includes an option-value network. An input of the high-level strategy network is the state of the robot sₜ, and an output is a high-level strategy value of oₜ.

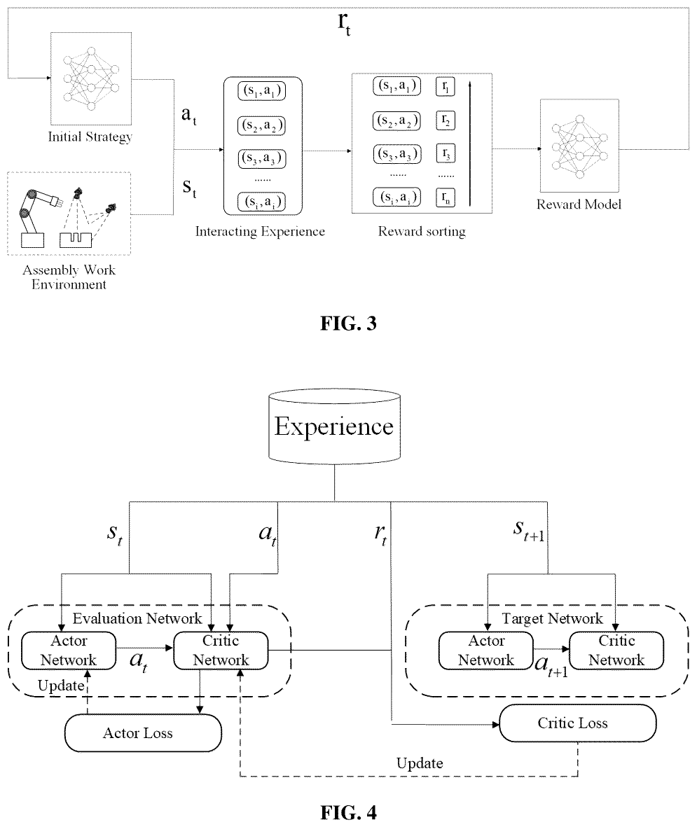

As shown in FIG. 4, the low-level strategy network adopts a SAC model, which includes two pairs of Actor networks and Critic networks, wherein, in an evaluation network of the SAC model, an input of the Actor network is states including the state of the end of robot and the output of the high-level strategy network, and an output is a corresponding action; an input of the Critic network is a state-action pair, and an output is a Loss value of the Actor network, which is used to update the Actor network. In a target network of the SAC model, inputs of the Actor network and the Critic network are state at the next time, an output of the Actor network is the action at the next time, and an output of the Critic network is a Loss value of the Critic network, which is used to update the Critic network in the evaluation network.

The low-level strategy network chooses actions based on the higher-level strategy network and under the state s by the formula as follows:

$${a}_{t} = {μ}_{o} ( s ) + ε ,$$

$$ε ∼ N ( 0 , σ )$$

wherein, μₒ(s) represents a low-level strategy under the choice of the high-level strategy o, ε is used to generate random noise, the robot performs the action aₜ, and gets the reward rₜ, and goes to the next state sₜ₊₁, and the (sₜ, aₜ, rₜ, sₜ₊₁) will be stored in a low-level experience pool.

As shown in FIG. 3, the data and the state-action pairs (sₜ, aₜ) obtained from the interaction between the initial strategy and the environment are manually sorted according to experience, and the data, after being labeled, are input into the reward function learning model for training.

Specifically, the data and the state-action pairs are evaluated and sorted manually based on a size of assembly force, an assembly depth of each step, an assembly speed, etc. of the assembly process, wherein the label is a sequence number of the sorting and also is the priority level.

The reward function learning model consists of a first convolution layer, a pooling layer and a second convolution layer, and a fully connected layer in sequence. An input of the reward function learning model is the state-action pairs (sₜ, aₜ) with labels, and an output is a reward value of a current state-action pair.

The output of the reward function learning model participates in a continuous updating of the “initial strategy” as the reward value. The “initial strategy” interacts with the environment to generate the state-action pairs, a model of the reward function can be obtained by manually participating in sorting and learning, and the reward value output by the model of the reward function is used to update the “initial strategy”, and move in circles so on.

The initial strategy is a strategy that has been learned so far, and the learning thereof and the reward function learning are alternately carried out. In the process of reward function learning, a current strategy can be called the initial strategy.

In the present embodiment, the data (sₜ, aₜ, sₜ₊₁, Rₜ₊₁) in the low-level experience pool is used to update the low-level strategy network, and the low-level strategy network is updated and trained by the SAC network, specifically:

### 1) Updating the Strategy Network-Actor Network:

Calculating a Q value of state-action in the strategy network at the current time:

$$Q ( {s}_{t} , {a}_{t} ) = {Q}_{Critic} ( {s}_{t} , {a}_{t} )$$

wherein, Q_{Critic} represents the Q value of the Critic network.

Calculating an entropy of actions generated by the strategy network:

$$H ( π ( {a}_{t} \vert {s}_{t} ) ) = - \int π ( {a}_{t} \vert {s}_{t} ) log π ( {a}_{t} \vert {s}_{t} ) da$$

wherein, π represents the strategy and H represents the entropy.

Calculating an objective entropy of the strategy network:

$${H}_{target} = target\_entropy \times H ( π ( {a}_{t} \vert {s}_{t} ) )$$

wherein, H_{target} represents the objective entropy of the strategy network.

Updating parameters of the strategy network by using a gradient descent method:

$${∇}_{{θ}_{Actor}} J ( {θ}_{Actor} ) \approx {∇}_{{θ}_{Actor}} ( Q ( s , a ) + α log π ( a \vert s ) - {H}_{target} )$$

wherein, J(θ_{Actor}) is the objective function of the strategy network, θ_{Actor} is the parameter of the strategy network, and α is the hyper parameter, which is used to ensure that the actions generated by the strategy network have certain exploratory properties.

### 2) Updating the Critic Network:

Calculating an objective of the Q value using collected empirical data:

$$y = {r}_{t} + γ ( 1 - d ) {Q}_{TargetCritic} ( {s}_{t + 1} , {π}_{TargetActor} ( {s}_{t + 1} ) )$$

wherein, rₜ is the reward value, γ is the discount factor, d is an indicator of whether the termination state has been reached, sₜ₊₁ is the next state, Q_{TargetCritic} is the target Q network, and π_{TargetActor} is the action generated by the target strategy network.

Updating and evaluating the parameters of the Critic network using the gradient descent:

$${∇}_{{θ}_{Critic}} J ( {θ}_{Critic} ) \approx {∇}_{{θ}_{Critic}} {( {Q}_{Critic} ( s , a ) - y )}^{2}$$

wherein, J(θ_{Critic}) is the objective function of the Critic network.

### 3) Updating the Parameters of the Target Critic Network Using a Moving Average Method:

$${θ}_{TargetCritic} ← τ {θ}_{Critic} + ( 1 - τ ) {θ}_{TargetCritic}$$

wherein, θ_{TargetCritic} represents the parameters of the target Critic network, θ_{Critic} represents the parameters of the Critic network. τ<1, is used to control the speed of the moving average.

Repeating steps 1) to 3) until the network update is complete.

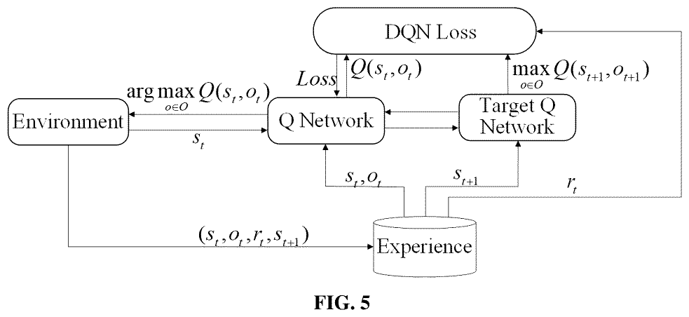

As shown in FIG. 5, in the present embodiment, the updating and training for the high-level strategy network is:

1) Calculating a Q value and a V value of a high-level network by using the formulas as follows:

$${Q}^{{π}^{H}} ( {s}_{t} , {o}_{t} ) = {E}_{{π}^{H}} [ {R}_{t}^{H} \vert {s}_{t} = s , {o}_{t} = o ]$$

$${V}^{{π}^{H}} ( {s}_{t} ) = {\sum }_{o ∈ O} {π}^{H} ( {o}_{t} \vert {s}_{t} ) {Q}^{{π}^{H}} ( {s}_{t} , {o}_{t} )$$

wherein, sₜ represents the state of the high-level network, oₜ represents the action of the high-level network, i.e., the high-level strategy, Rₜ^{H} represents the reward function, and E_{π}_{^{H}} represents the mean.

2) Calculating a dominance function of the high-level strategy as follows, the dominance function indicates the importance of the selected state-action pair.

$${A}^{{π}^{H}} ( {s}_{t} , {o}_{t} ) = {Q}^{{π}^{H}} ( {s}_{t} , {o}_{t} ) - {V}^{{π}^{H}} ( {s}_{t} )$$

3) Outputting, by the DQN network, a final high-level strategy o with a probability of choosing o is 1−ε.

$$o = arg {max}_{{o}^{′} ∈ O} {Q}^{H} ( s , {o}^{′} )$$

4) Updating an estimation of a target Q-value function according to the state:

$$target = r + γ * max ( Q ( {s}_{t + 1} , o ) )$$

wherein, γ is the discount factor that weighs the importance of current rewards against future rewards.

5) Finally, updating an estimation of the Q-value function estimate at the current state by using the current state sₜ, a performed action oₜ, an observed new state sₜ₊1, and a reward value rₜ₊₁:

$$Q ( {s}_{t} , {o}_{t} ) = Q ( {s}_{t} , {o}_{t} ) + α * ( target - Q ( {s}_{t} , {o}_{t} ) )$$

In the present embodiment, the interaction data acquired in each the sub-process is transmitted to the main process to update the main network model, and the updated main network model assigns network weights to each the sub-network:

ϕ₁ ← ϕ
ϕ₂ ← ϕ
. . .
ϕₙ ← ϕ

wherein, ϕ represents the weight of the main network and ϕ₁, ϕ₂, . . . , ϕₙ represents the weight of each the sub-network respectively.

And, executing the assembly task of complex multi-peg-in-hole assembly by using the trained off-line model of the master network.

### Embodiment 2

An object of the present embodiment is to provide a system for a robotic multi-peg-in-hole assembly based on hierarchical reinforcement learning and distributed learning, comprising:
a master-control assembly-strategy model establishing module, being configured to: establish a master-control assembly-strategy model based on deep reinforcement learning by using data of states and actions of a robot;
a master-control assembly-strategy model training module, being configured to: construct a plurality of sub-process networks based on different assembly interaction environments, update and train the master-control assembly-strategy model by utilizing interaction data of the robot obtained by the constructed plurality of sub-process networks, and obtain a trained master-control assembly-strategy model; wherein,
each of the plurality of sub-process network comprises a high-level strategy network and a low-level strategy network, wherein the high-level strategy network obtains a high-level strategy value according to data of a state of the robot at a current time, and the low-level strategy network obtains an action of the robot at a next time according to the high-level strategy value and the data of the state of the robot at the current time;
and, a robot controlling and executing module, being configured to: control and instruct the robot to execute an assembly task of a robotic multi-peg-in-hole assembly by utilizing the trained master-control assembly-strategy model.

### Embodiment 3

It is an object of the present embodiment to provide a computer device comprising a memory, a processor, and a computer program stored on the memory and executable by the processor, when the computer program executed by the processor, implementing the steps of the method described above.

### Embodiment 4

It is an object of the present embodiment to provide a non-transitory computer-readable storage medium.

The non-transitory computer-readable storage medium has a computer program stored thereon, when the computer program executed by a processor, implementing the steps of the method described above.

The steps involved in the apparatuses of the above Embodiments 2, 3 and 4 correspond to those of the method of the Embodiment 1, and the specific implementation mode can be referred to the relevant description part of the Embodiment 1. the term “computer-readable storage medium” should be understood to include a single medium or multiple media comprising one or more sets of instructions; and should also be understood to include any medium capable of storing, encoding, or carrying a set of instructions for execution by a processor and causing the processor to perform any of the methodologies of the present invention.

those skilled in the art will appreciate that the various modules or steps of the present invention described above may be implemented using general purpose computer means, alternatively they may be implemented using program code executable by computing means such that they may be stored in memory means for execution by computing means, or fabricated separately as individual integrated circuit modules, or multiple of them may be fabricated as a single integrated circuit module. The present invention is not limited to any particular combination of hardware and software.

Although the specific embodiments of the present invention are described above in combination with the accompanying drawings, it is not a limitation on the protection scope of the present invention. Those skilled in the art should understand that on the basis of the technical solutions of the present invention, various modifications or deformations that can be made by those skilled in the art without creative labor are still within the protection scope of the present invention.

1.-10. (canceled)

11. A method for a robotic multi-peg-in-hole assembly based on hierarchical reinforcement learning and distributed learning, comprising:
establishing a master-control assembly-strategy model based on deep reinforcement learning by using data of states and actions of a robot;
constructing a plurality of sub-process networks based on different assembly interaction environments, updating and training the master-control assembly-strategy model by using interaction data of the robot obtained by the constructed plurality of sub-process networks, and obtaining a trained master-control assembly-strategy model; wherein,
each of the plurality of sub-process networks comprises a high-level strategy network and a low-level strategy network, wherein the high-level strategy network obtains a high-level strategy value according to data of a state of the robot at a current time, and the low-level strategy network obtains an action of the robot at a next time according to the high-level strategy value and the data of the state of the robot at the current time;
and, controlling and instructing the robot to execute an assembly task of a multi-peg-in-hole assembly by using the trained master-control assembly-strategy model.

12. The method for the robotic multi-peg-in-hole assembly based on hierarchical reinforcement learning and distributed learning according to claim 11, wherein the data of the states of the robot comprises a pose of component at an end of the robot, a value of contact force/torque at the end of the robot, and image data of assembly acquired by cameras.

13. The method for the robotic multi-peg-in-hole assembly based on hierarchical reinforcement learning and distributed learning according to claim 11, wherein using the data of the state of the robot at the current time as an input of the high-level strategy network to obtain a corresponding high-level strategy value.

14. The method for the robotic multi-peg-in-hole assembly based on hierarchical reinforcement learning and distributed learning according to claim 11, wherein the low-level strategy network comprises an evaluation network and a target network, the evaluation network and the target network respectively comprise an Actor network and a Critic network, and the data of the states of the robot and an output of the high-level strategy network are used as an input of the Actor network in the evaluation network to obtain an action of the robot in a current state;
obtaining a first loss value of the Actor network of the evaluation network by using the data of the states and the actions of the robot as an input of the Critic network in the evaluation network, and updating the Actor network of the evaluation network according to the loss value; and
using data of a state of the robot at the next time as an input respectively of the Actor network and the Critic network in the target network, an output of the Actor network in the target network is an action corresponding to the next time, an output of the Critic network in the target network is a second loss value of the Critic network in the evaluation network, and updating the Critic network in the evaluation network based on the second loss value.

15. The method for the robotic multi-peg-in-hole assembly based on hierarchical reinforcement learning and distributed learning according to claim 11, wherein storing the state of the robot at the current time, the action corresponding to the state of the robot at the current time, a reward obtained by executing the action corresponding to the state of the robot at the current time, and the action of the robot at the next time in a low-level experience pool, and updating the low-level strategy network by using the low-level experience pool.

16. The method for the robotic multi-peg-in-hole assembly based on hierarchical reinforcement learning and distributed learning according to claim 15, wherein using the state of the robot at the current time and the action corresponding to the state of the robot at the current time as a state-action pair, manually sorting state-action pairs according to experience, a sequence number after the sorting is regarded as a label of a corresponding state-action pair, training a reward function model by using the state-action pairs and sequence numbers corresponding to the state-action pairs, and obtaining a reward value of an input state of the robot and an action corresponding to the input state based on the trained reward function model.

17. The method for the robotic multi-peg-in-hole assembly based on hierarchical reinforcement learning and distributed learning according to claim 11, wherein training an Actor network of the low-level strategy network comprising: calculating a Q value of state-action and an entropy of the action in a strategy network at the current time, obtaining an objective entropy of the strategy network according to the entropy of the action, and updating parameters of the Actor network in the strategy network by using a gradient descent method combined with the Q value of state-action and the objective entropy; and
training a Critic network of the low-level strategy network comprising: calculating a target of the Q value of state-action based on empirical data, updating parameters of the Critic network in the evaluation network by using the gradient descent method combined with the target of the Q value of state-action, and updating parameters of the Critic network in a target network by using a moving average method and the parameters of the Critic network in the evaluation network.

18. A system for a robotic multi-peg-in-hole assembly based on hierarchical reinforcement learning and distributed learning, comprising:
a master-control assembly-strategy model establishing module, being configured to: establish a master-control assembly-strategy model based on deep reinforcement learning by using data of states and actions of a robot;
a master-control assembly-strategy model training module, being configured to: construct a plurality of sub-process networks based on different assembly interaction environments, update and train the master-control assembly-strategy model by using interaction data of the robot obtained by the constructed plurality of sub-process networks, and obtain a trained master-control assembly-strategy model; wherein,
each of the plurality of sub-process networks comprises a high-level strategy network and a low-level strategy network, wherein the high-level strategy network obtains a high-level strategy value according to data of a state of the robot at a current time, and the low-level strategy network obtains an action of the robot at a next time according to the high-level strategy value and the data of the state of the robot at the current time;
and, a robot controlling and executing module, being configured to: control and instruct the robot to execute an assembly task of a robotic multi-peg-in-hole assembly by using the trained master-control assembly-strategy model.

19. A computer device, comprising: a processor, a memory, and a bus, wherein the memory stores machine-readable instructions executable by the processor, and when the computer device is running, the processor communicates with the memory via the bus, wherein when the machine-readable instructions are executed by the processor, implementing the method for the robotic multi-peg-in-hole assembly based on hierarchical reinforcement learning and distributed learning according to claim 11.

20. A non-transitory computer-readable storage medium, having a computer program stored thereon, wherein when the computer program is executed by a processor, implementing the method for the robotic multi-peg-in-hole assembly based on hierarchical reinforcement learning and distributed learning according to claim 11.
